(19) United States
(12) Patent Application Publication
(10) Pub. No.: US 2026/0120943 A1
(43) Pub. Date: Apr. 30, 2026

(54) COIL COMPONENT

(71) Applicant: Murata Manufacturing Co., Ltd., Kyoto-fu (JP)

(72) Inventors: Hiderou YAMASAKI, Nagaokakyo-shi (JP); Keita ASAI, Nagaokakyo-shi (JP)

(73) Assignee: Murata Manufacturing Co., Ltd., Kyoto-fu (JP)

(21) Appl. No.: 19/355,690

(22) Filed: Oct. 10, 2025

(30) Foreign Application Priority Data
Oct. 31, 2024 (JP) 2024-191793

(51) Int. Cl. H01F 27/29; H01F 27/24

(52) U.S. Cl. CPC H01F 27/29; H01F 27/24

(57) ABSTRACT

A coil component has a core portion and first and second wires would around the core portion. A 35th turn of a second wire has a first crossing point where the 35th turn of the second wire on an outside of a 35th turn of a first wire crosses the 35th turn of the first wire. A 36th turn of the second wire includes a specific part located between the 35th turn of the first wire and the 35th turn of the second wire in a direction along a central axis of a winding core portion. A part of the 36th turn of the second wire closer to a second wire end than the specific part has a third crossing point where the 36th turn of the second wire on an outside of the 35th turn of the second wire crosses the 35th turn of the second wire.

### CROSS-REFERENCE TO RELATED APPLICATION

This application claims benefit of priority to Japanese Patent Application No. 2024-191793, filed Oct. 31, 2024, the entire content of which is incorporated herein by reference.

### BACKGROUND

### Technical Field

The present disclosure relates to a coil component.

### Background Art

A common mode filter described in Japanese Unexamined Patent Application Publication No. 2018-120885 includes a drum-shaped core, a first wire, and a second wire. The drum-shaped core includes a winding core portion having a quadrangular prism shape, a first flange portion provided at a first end of the winding core portion, and a second flange portion provided at a second end of the winding core portion. The first wire is wound around the winding core portion. The second wire is wound around the winding core portion on the outside of the first wire. In addition, a predetermined turn of the second wire has a crossing point where the first wire and the second wire cross each other.

### SUMMARY

In the common mode filter described in Japanese Unexamined Patent Application Publication No. 2018-120885, the first wire and the second wire are spirally wound around the winding core portion basically at a uniform pitch. However, in the vicinity of such a crossing point, each wire is wound at a pitch different from that of the other part thereof. Thus, a space where the second wire is not wound is likely to be formed in the vicinity of the crossing point of the second wire in the direction along the central axis of the winding core portion. Such a space inhibits high-density winding of the second wire.

Therefore, according to an aspect, a coil component includes a winding core portion having a columnar shape; a first flange portion provided at a first end of the winding core portion in a direction along a central axis of the winding core portion; a second flange portion provided at a second end of the winding core portion opposite to the first end; a first outer electrode and a second outer electrode that are provided on the first flange portion; and a third outer electrode and a fourth outer electrode that are provided on the second flange portion. The coil component also includes a first wire wound around the winding core portion, the first wire having a first wire end and a second wire end, the first wire end of the first wire being connected to the first outer electrode, the second wire end of the first wire being connected to the third outer electrode; and a second wire wound around the winding core portion in the same direction as the first wire, the second wire having a first wire end and a second wire end, the first wire end of the second wire being connected to the second outer electrode, the second wire end of the second wire being connected to the fourth outer electrode. When each time the first wire is wound around the central axis in a direction from the first wire end toward the second wire end and forms one turn, the number of turns of the first wire increases by one, and when each time the second wire is wound around the central axis in a direction from the first wire end toward the second wire end and forms one turn, the number of turns of the second wire increases by one, a j-th turn (j is an integer of 2 or more) of the second wire has a first crossing point where the j-th turn of the second wire on an outside of an i-th turn (i is an integer of 2 or more) of the first wire crosses the i-th turn of the first wire, a (j+1)-th turn of the second wire includes a specific part located between the i-th turn of the first wire and the j-th turn of the second wire in the direction along the central axis of the winding core portion, and a part of the (j+1)-th turn of the second wire closer to the second wire end than the specific part on an outside of the j-th turn of the second wire crosses the j-th turn of the second wire.

It is possible to reduce the space where the second wire is not wound in the vicinity of the crossing point of the second wire in the direction along the central axis.

### BRIEF DESCRIPTION OF THE DRAWINGS

FIG. 1 is a perspective view of a coil component;

FIG. 2 is a schematic end view of the coil component along an end face that includes a central axis and that is orthogonal to a left-right axis, the schematic end view illustrating the winding structure of respective wires;

FIG. 3 is a partial enlarged view of FIG. 2;

FIG. 4 is a partial schematic top view of the coil component illustrating the winding structure of the respective wires; and

FIG. 5 is a partial schematic top view of a coil component in a modification example.

### DETAILED DESCRIPTION

### Embodiment of Coil Component

An embodiment of a coil component will be described below. Figures illustrate enlarged components to facilitate understanding in some cases. The size ratios of components differ from those of actual ones or those in other figures in some cases.

### Overall Configuration

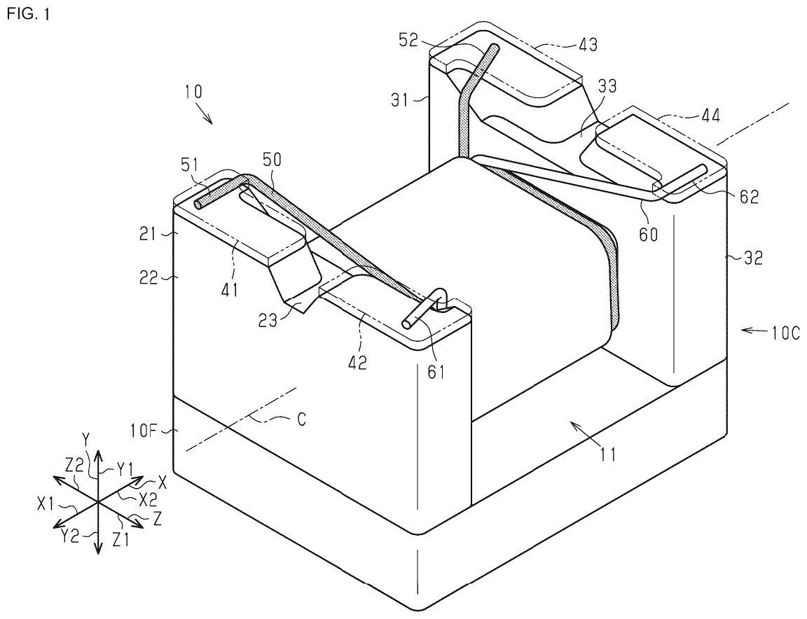

As illustrated in FIG. 1, a coil component 10 includes a drum core 10C, and a plate core 10F.

The drum core 10C includes a winding core portion 11, a first flange portion 21, and a second flange portion 31.

The winding core portion 11 has a quadrangular prism shape whose section has a rectangular shape. That is, the winding core portion 11 has four side surfaces. The material for the winding core portion 11 is, for example, Ni—Zn-based ferrite.

The first flange portion 21 is provided at a first end of the winding core portion 11 in a direction along a central axis C of the winding core portion 11. Specifically, the first flange portion 21 is connected to the first end of the winding core portion 11 in the direction along the central axis C. The second flange portion 31 is provided at a second end of the winding core portion 11 in the direction along the central axis C. Specifically, the second flange portion 31 is connected to the second end of the winding core portion 11 in the direction along the central axis C. The material for the first flange portion 21 and the second flange portion 31 is the same as that of the winding core portion 11. In addition, the first flange portion 21 and the second flange portion 31 are integrally formed with the winding core portion 11.

Here, an axis parallel to the central axis C is a core axis X. In addition, a specific axis orthogonal to the core axis X is an up-down axis Y. In the present embodiment, the up-down axis Y extends in a direction orthogonal to a mounting surface when the coil component 10 is mounted on a board. In addition, an axis orthogonal to both the core axis X and the up-down axis Y is a left-right axis Z. Then, one direction along the core axis X is a positive direction X1, and the direction opposite to the positive direction X1 is a negative direction X2. In the present embodiment, the positive direction X1 corresponds to a direction from the winding core portion 11 toward the first flange portion 21. The negative direction X2 corresponds to a direction from the winding core portion 11 toward the second flange portion 31. In addition, one direction along the up-down axis Y is an upward direction Y1, and the direction opposite to the upward direction Y1 is a downward direction Y2. In addition, one direction along the left-right axis Z is a rightward direction Z1, and the direction opposite to the rightward direction Z1 is a leftward direction Z2. The names of the upward direction Y1 and the downward direction Y2 herein are selected for convenience and do not specify the direction of gravity. In addition, the names of the rightward direction Z1 and the leftward direction Z2 are also selected for convenience and do not specify the left-right direction from a specific viewpoint.

The shape of a section of the winding core portion 11 orthogonal to the central axis C is a rectangular shape. That is, the area of each of two side surfaces of the four side surfaces of the winding core portion 11 is larger than the area of each of the other two side surfaces. Then, one of the side surfaces having a larger area faces in the upward direction Y1. The other of the side surfaces having a larger area faces in the downward direction Y2.

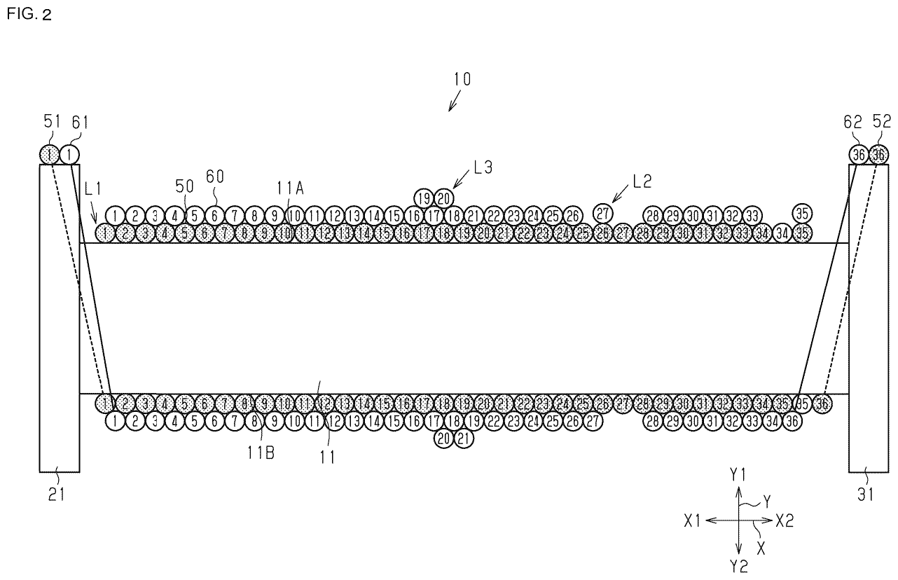

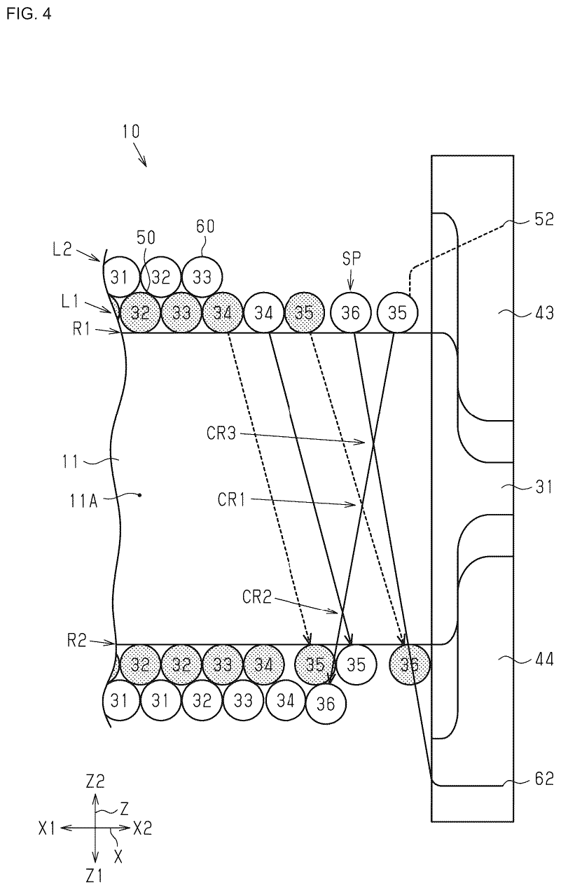

Hereinafter, as illustrated in FIG. 2, the side surface facing in the upward direction Y1 is a specific side surface 11A, and the side surface opposite to the specific side surface 11A is an opposite surface 11B. The specific side surface 11A does not necessarily have to be a flat surface whose entire region is orthogonal to the up-down axis Y. That is, the surface of the winding core portion 11 visible when the coil component 10 is viewed in the downward direction Y2 from the upward direction Y1 side of the coil component 10 is the specific side surface 11A. In addition, as illustrated in FIG. 4, of two edge lines between the specific side surface 11A and the other side surfaces adjacent thereto, the edge line on the leftward direction Z2 side is a first edge line R1. In addition, of the edge lines between the specific side surface 11A and the other side surfaces, the edge line on the rightward direction Z1 side is a second edge line R2.

As illustrated in FIG. 1, the first flange portion 21 projects outward from the winding core portion 11 in the directions along the up-down axis Y and the left-right axis Z when the first flange portion 21 is viewed in the direction along the central axis C. The first flange portion 21 has a shape symmetrical with respect to an imaginary plane that includes the central axis C and that is orthogonal to the left-right axis Z.

The first flange portion 21 includes a main body 22 and a recessed portion 23. On the whole, the main body 22 has a cuboid shape whose thickness in the direction along the central axis C is thin. When viewed in the negative direction X2, respective edges of the main body 22 on the upward direction Y1 side and the downward direction Y2 side are parallel to the left-right axis Z. In addition, when viewed in the negative direction X2, respective edges of the main body 22 on the leftward direction Z2 side and the rightward direction Z1 side are parallel to the up-down axis Y.

The recessed portion 23 is recessed in the downward direction Y2 from an upper surface of the main body 22. The dimension of the recessed portion 23 in the direction along the left-right axis Z is reduced in the downward direction Y2. The recessed portion 23 is located at substantially the center of the main body 22 in the direction along the left-right axis Z. The dimension of the recessed portion 23 in the direction along the central axis Cis equal to the dimension of the main body 22 in the direction along the central axis C. That is, the part of the first flange portion 21 on the upward direction Y1 side is shaped so as to be divided into two parts with the recessed portion 23 interposed therebetween.

The second flange portion 31 and the first flange portion 21 have a shape symmetrical with respect to an imaginary plane that passes through the center of the winding core portion 11 in the direction along the central axis C and that is orthogonal to the central axis C. That is, the second flange portion 31 projects outward from the winding core portion 11 in the directions along the up-down axis Y and the left-right axis Z when the second flange portion 31 is viewed in the direction along the central axis C. Then, the second flange portion 31 includes a main body 32 and a recessed portion 33. The configuration of the main body 32 and the recessed portion 33 of the second flange portion 31 is the same as that of the main body 22 and the recessed portion 23 of the first flange portion 21. That is, the recessed portion 33 is recessed in the downward direction Y2 from an upper surface of the main body 32.

The plate core 10F has a rectangular plate-like shape. The long sides of the plate core 10F are parallel to the central axis C. The short sides of the plate core 10F are parallel to the left-right axis Z. The plate core 10F is located on the downward direction Y2 side of the drum core 10C. The plate core 10F is connected to both a lower surface of the first flange portion 21 and a lower surface of the second flange portion 31. That is, the plate core 10F is spanned between the first flange portion 21 and the second flange portion 31. The material for the plate core 10F is the same as the material for the drum core 10C. Although not illustrated, an adhesive is interposed between the plate core 10F and each of the first flange portion 21 and the second flange portion 31.

As illustrated in FIG. 1, the coil component 10 includes a first outer electrode 41, a second outer electrode 42, a third outer electrode 43, and a fourth outer electrode 44.

The first outer electrode 41 is provided on the first flange portion 21. That is, the first outer electrode 41 is attached onto a surface of the first flange portion 21. The first outer electrode 41 is located on the surface of the first flange portion 21 on the upward direction Y1 side and is located on the leftward direction Z2 side of the recessed portion 23.

The second outer electrode 42 is provided on the first flange portion 21. That is, the second outer electrode 42 is attached onto a surface of the first flange portion 21. The second outer electrode 42 is located on the surface of the first flange portion 21 on the upward direction Y1 side and is located on the rightward direction Z1 side of the recessed portion 23.

The third outer electrode 43 is provided on the second flange portion 31. That is, the third outer electrode 43 is attached onto a surface of the second flange portion 31. The third outer electrode 43 is located on the surface of the second flange portion 31 on the upward direction Y1 side and is located on the leftward direction Z2 side of the recessed portion 33.

The fourth outer electrode 44 is provided on the second flange portion 31. That is, the fourth outer electrode 44 is attached onto a surface of the second flange portion 31. The fourth outer electrode 44 is located on the surface of the second flange portion 31 on the upward direction Y1 side and is located on the rightward direction Z1 side of the recessed portion 33.

Although not illustrated, the first outer electrode 41 to the fourth outer electrode 44 each include a metal layer and a plating layer. For example, the metal layer is a layer containing silver as a main component. For example, the plating layer is formed by a plurality of layers such as a layer containing copper as a main component, a layer containing nickel as a main component, and a layer containing tin as a main component. In the present embodiment, the surfaces of the coil component 10 on which the first outer electrode 41 to the fourth outer electrode 44 are provided are surfaces facing a board when the coil component 10 is mounted on the board. FIG. 1 illustrates the first outer electrode 41 to the fourth outer electrode 44 with long dashed double-short dashed line.

### Configuration of First Wire and Second Wire

As illustrated in FIG. 1, the coil component 10 includes a first wire 50 and a second wire 60. The first wire 50 and the second wire 60 include parts wound around the winding core portion 11. FIG. 1 simplifies the winding structure of the parts wound around the winding core portion 11 of the first wire 50 and the second wire 60 and illustrates the winding structure as a tubular object formed by integrating respective turns of each wire.

Although not illustrated, the first wire 50 includes a conductor and an insulating coating. The insulating coating covers an outer peripheral surface of the conductor. A section of the first wire 50 orthogonal to the direction in which the first wire 50 extends has a substantially circular shape. The first wire 50 has a first wire end 51 and a second wire end 52 opposite to the first wire end 51. In each figure, the first wire 50 is colored with dots.

As illustrated in FIG. 1, the first wire end 51 of the first wire 50 is connected to the first outer electrode 41. The second wire end 52 of the first wire 50 is connected to the third outer electrode 43. Here, when the first wire 50 is traced from the first wire end 51 to the second wire end 52, the position where the first wire 50 first comes into contact with an outer peripheral surface of the winding core portion 11 is the position of a 1.0 turn of the first wire 50. In the present embodiment, the position of the 1.0 turn of the first wire 50 is located on the second edge line R2 of the winding core portion 11.

As illustrated in FIG. 2, each time the first wire 50 is wound around the central axis C in the direction from the first wire end 51 toward the second wire end 52 and forms one turn, the number of turns of the first wire 50 increases by one. When viewed in the negative direction X2, the first wire 50 is wound around the winding core portion 11 so as to be shifted clockwise as the number of turns thereof increases. Thus, as illustrated in FIG. 4, when the first wire 50 is traced from the first wire end 51 to the second wire end 52, the first wire 50 passes the first edge line R1 and the second edge line R2 in this order on the specific side surface 11A.

More specifically, for example, when viewed in the negative direction X2, the position of the first wire 50 shifted clockwise by 36 degrees around the central axis C from the position of the 1.0 turn of the first wire 50 is the position of a 1.1 turn of the first wire 50. In addition, a first turn of the first wire 50 represents a part of the first wire 50 from the position of the 1.0 turn of the first wire 50 to a position immediately preceding the position of a 2.0 turn of the first wire 50. In addition, the last turn of the first wire 50 is a turn including the position where the first wire 50 lastly comes into contact with the outer peripheral surface of the winding core portion 11 when the first wire 50 is traced from the first wire end 51 to the second wire end 52. FIGS. 2 to 4 illustrate any part of the first turn within the range of the first turn as “1”. The same applies to the cases of other turn numbers. In some cases, the turn numbers illustrated in FIGS. 2 to 4 do not correspond to the turn numbers counted from the first turn in the manufacture. In addition, FIG. 4 does not illustrate each wire on the specific side surface 11A as a thick wire but as a simplified line. FIG. 4 illustrates the first wire 50 as a dashed line and the second wire 60 as a solid line.

As illustrated in FIG. 1, the second wire 60 has the same configuration as that of the first wire 50. That is, the second wire 60 includes a conductor and an insulating coating. The insulating coating covers an outer surface of the conductor. A section of the second wire 60 orthogonal to the direction in which the second wire 60 extends has a substantially circular shape. The second wire 60 has a first wire end 61 and a second wire end 62 opposite to the first wire end 61.

As illustrated in FIG. 1, the first wire end 61 of the second wire 60 is connected to the second outer electrode 42. The second wire end 62 of the second wire 60 is connected to the fourth outer electrode 44. Here, when the second wire 60 is traced from the first wire end 61 to the second wire end 62, the position where the angular position of the second wire 60 around the central axis C first corresponds to the angular position of the 1.0 turn of the first wire 50 is the position of a 1.0 turn of the second wire 60. That is, in the present embodiment, the position of the 1.0 turn of the second wire 60 is located on a half line extending from the central axis C to the second edge line R2 of the winding core portion 11 when viewed in the direction along the central axis C.

As illustrated in FIG. 2, each time the second wire 60 is wound around the central axis C in the direction from the first wire end 61 toward the second wire end 62 and forms one turn, the number of turns of the second wire 60 increases by one. When viewed in the negative direction X2, the second wire 60 is wound around the winding core portion 11 clockwise as the number of turns thereof increases. That is, the second wire 60 is wound around the winding core portion 11 in the same direction as the first wire 50. Thus, as illustrated in FIG. 4, when the second wire 60 is traced from the first wire end 61 to the second wire end 62, the second wire 60 passes the first edge line R1 and the second edge line R2 in this order on the specific side surface 11A. The manner of counting the turns of the second wire 60 is the same as that of the first wire 50.

Hereinafter, the parts of the first wire 50 and the second wire 60 directly wound around the winding core portion 11 form a first layer L1. Here, the state of “being directly wound around” may be the state in which wires are apart from the winding core portion 11 in addition to the state of being in contact with the outer peripheral surface of the winding core portion 11 and also includes the state in which one wire is wound around the winding core portion 11 without the other wire interposed therebetween.

In addition, the parts of the first wire 50 and the second wire 60 wound, on the outside in the direction orthogonal to the central axis C, around the outside between the parts of the wire of the first layer L1 adjacent to each other in the direction along the central axis C form a second layer L2. In addition, the parts of the first wire 50 and the second wire 60 wound, on the outside in the direction orthogonal to the central axis C, around the outside between the parts of the wire of the second layer L2 adjacent to each other in the direction along the central axis C form a third layer L3.

### Specific Winding Structure of First Wire and Second Wire

As illustrated in FIG. 2, substantially the all turns of the first wire 50 belong to the first layer L1. The first turn to a 36th turn of the first wire 50 are wound. That is, the last turn of the first wire 50 is the 36th turn.

The first turn to the 36th turn of the first wire 50 are wound in the order so as to be located closer to the second flange portion 31 in the direction along the central axis C the higher the turn number. In addition, the first turn to a part of a 35th turn of the first wire 50 are wound adjacent to each other in the direction along the central axis C. Then, the part of the 35th turn to the 36th turn of the first wire 50 are disposed so as to be spaced from a different turn of the first wire 50 adjacent in the positive direction X1. Then, as described below, the second wire 60 is located in this space.

Here, the state of “being wound adjacent to each other” is not limited to the case in which the turns of the wire adjacent to each other are in contact with each other. Even if the turns of the wire adjacent to each other are not in contact with each other, it can be said that the turns of the wire are adjacent to each other unless the other wire exists on a line segment connecting the centers of the parts of the wire adjacent to each other in end view.

A first turn to a 36th turn of the second wire 60 are wound. That is, a last turn of the second wire 60 is the 36th turn. Most of the second wire 60 belongs to the second layer L2. However, the second wire 60 also includes a part belonging to the first layer L1, and a part belonging to the third layer L3.

The part of the second wire 60 closer to the first wire end 61 than the 1.0 turn is not located on the specific side surface 11A. Thus, the part of the second wire 60 closer to the first wire end 61 than the 1.0 turn does not include a part crossing the first wire 50 on the specific side surface 11A. In addition, the entire region of the first turn of the second wire 60 is located on the outside between the first turn and a second turn of the first wire 50. Thus, the first turn of the second wire 60 does not include a part crossing the first wire 50 on the specific side surface 11A.

A second turn of the second wire 60 is located on the outside between the second turn and a third turn of the first wire 50. A third turn of the second wire 60 is located on the outside between the third turn and a fourth turn of the first wire 50. In this manner, within the range of the first turn to a part of a 19th turn of the second wire 60, an n-th turn of the second wire 60 is wound around the outside between an n-th turn and an (n+1)-th turn of the first wire 50. Here, “n” is an integer of 1 or more and 19 or less (i.e., from 1 to 19). Thus, the first turn to the part of the 19th turn of the second wire 60 belong to the second layer L2.

The other part of the 19th turn of the second wire 60 is extended toward the positive direction X1. Specifically, the part of the 19th turn of the second wire 60 on the opposite surface 11B is wound around the outside between a 19th turn and a 20th turn of the first wire 50. Then, the 19th turn of the second wire 60 is extended toward the first flange portion 21 and is wound around the outside between a 16th turn and a 17th turn of the second wire 60 on the specific side surface 11A. Thus, the 19th turn of the second wire 60 crosses an 18th turn and a 17th turn of the second wire 60 on the side surface facing in the leftward direction Z2.

A 20th turn of the second wire 60 is wound around the outside between the 17th turn and the 18th turn of the second wire 60. A part of a 21st turn of the second wire 60 is wound around the outside between the 18th turn and a 19th turn of the second wire 60. Then, the 21st turn of the second wire 60 is wound around the outside between the 19th turn and the 20th turn of the first wire 50. Specifically, the part of the 21st turn of the second wire 60 on the opposite surface 11B is wound around the outside between the 18th turn and the 19th turn of the second wire 60. Then, the part of the 21st turn of the second wire 60 on the specific side surface 11A is wound around the outside between the 19th turn and the 20th turn of the first wire 50. Thus, the 21st turn of the second wire 60 crosses the 19th turn of the second wire 60 on the side surface facing in the leftward direction Z2. In this manner, the other part of the 19th turn to the part of the 21st turn of the second wire 60 belong to the third layer L3.

A 22nd turn of the second wire 60 is located on the outside between the 20th turn and a 21st turn of the first wire 50. In addition, a 23rd turn of the second wire 60 is located on the outside between the 21st turn and a 22nd turn of the first wire 50. In this manner, within the range of the 22nd turn to a part of a 27th turn of the second wire 60, an n-th turn of the second wire 60 is wound around the outside between an (n−2)-th turn and an (n−1)-th turn of the first wire 50. Here, n is an integer of 22 or more and 27 or less (i.e., from 22 to 27).

The 27th turn of the second wire 60 crosses a 26th turn and a 27th turn of the first wire 50 on the specific side surface 11A in the direction from the first flange portion 21 side toward the second flange portion 31 side.

A 28th turn of the second wire 60 is located on the outside between a 28th turn and a 29th turn of the first wire 50. In addition, a 29th turn of the second wire 60 is located on the outside between the 29th turn and a 30th turn of the first wire 50. In this manner, within the range of the 28th turn to a part of a 34th turn of the second wire 60, an n-th turn of the second wire 60 is wound around the outside between an n-th turn and an (n+1)-th turn of the first wire 50. Here, n is an integer of 28 or more and 34 or less (i.e., from 28 to 34). In addition, the other part of the 21st turn to the part of the 34th turn of the second wire 60 belong to the second layer L2.

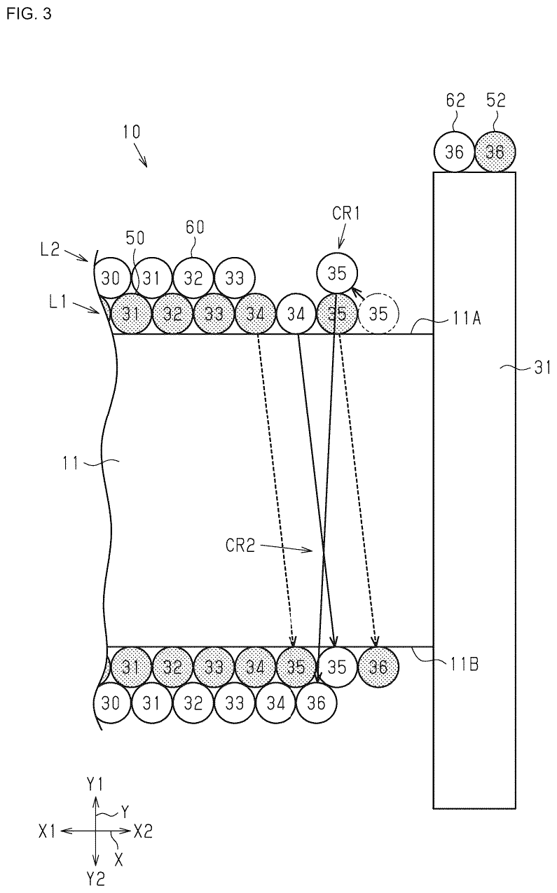

As illustrated in FIG. 3, the part of the 34th turn of the second wire 60 located on the specific side surface 11A is directly wound around the winding core portion 11 between a 34th turn and the 35th turn of the first wire 50.

As illustrated in FIG. 4, a part of a 35th turn of the second wire 60 is adjacent to the 35th turn of the first wire 50 in the negative direction X2 and is directly wound around the winding core portion 11. Then, the 35th turn of the second wire 60 has a first crossing point CR1 where the 35th turn of the second wire 60 on the outside of the 35th turn of the first wire 50 crosses the 35th turn of the first wire 50 on the specific side surface 11A. As illustrated in FIG. 3, in the vicinity of the first crossing point CR1, the 35th turn of the second wire 60 that has belonged to the first layer L1 is located on the 35th turn of the first wire 50 and forms the second layer L2.

As illustrated in FIG. 4, the part of the 35th turn of the second wire 60 closer to the second wire end 62 than the first crossing point CR1 has a second crossing point CR2 where the 35th turn of the second wire 60 on the outside of the 34th turn of the second wire 60 crosses the 34th turn of the second wire 60 on the specific side surface 11A. Then, when the second wire 60 is traced from the first crossing point CR1 to the second crossing point CR2 in the direction from the first wire end 61 side toward the second wire end 62 side, the second wire 60 extends from the second flange portion 31 side toward the first flange portion 21 side. In other words, the second crossing point CR2 is located on the positive direction X1 side of the first crossing point CR1. Then, the part of the 35th turn of the second wire 60 from the second crossing point CR2 to a position immediately preceding the 36th turn is wound around the outside between the 34th turn of the first wire 50 and the 34th turn of the second wire 60.

A part of the 36th turn of the second wire 60 is wound around the outside between the 35th turn of the first wire 50 and the 35th turn of the second wire 60. Then, the other part of the 36th turn of the second wire 60 is a specific part SP directly wound around the winding core portion 11. The specific part SP is located between the 35th turn of the first wire 50 and the 35th turn of the second wire 60 in the direction along the central axis C of the winding core portion 11. In addition, the specific part SP includes a part located on the first edge line R1 of the winding core portion 11.

The part of the second wire 60 closer to the second wire end 62 than the specific part SP is separate from the side surface of the winding core portion 11 and reaches the fourth outer electrode 44. Then, the second wire end 62 of the second wire 60 is connected to the fourth outer electrode 44. As a result, the part of the 36th turn of the second wire 60 closer to the second wire end 62 than the specific part SP has a third crossing point CR3 where the 36th turn of the second wire 60 on the outside of the 35th turn of the second wire 60 crosses the 35th turn of the second wire 60. Then, the third crossing point CR3 is located on the specific side surface 11A.

The 35th turn and the 36th turn of the second wire 60 are not in contact with each other at the third crossing point CR3. That is, at the third crossing point CR3, the 36th turn of the second wire 60 is apart from the 35th turn of the second wire 60 in the upward direction Y1. In this manner, for example, it is sufficient that the “crossing point” be a point where the two wires cross each other when viewed through in a direction orthogonal to the specific side surface 11A, and the two wires do not have to be in contact with each other.

As described above, the second wire 60 has the first crossing point CR1, the second crossing point CR2, the third crossing point CR3, and other crossing points on the specific side surface 11A. In addition, the second wire 60 has crossing points on the side surface facing in the leftward direction Z2 of the side surfaces of the winding core portion 11. On the other hand, the second wire 60 has no crossing points on the opposite surface 11B.

Here, i is 35, and j is 35. In this case, a (j+1)-th turn of the second wire 60 is the last turn of the second wire 60. In addition, when i is 35 and j is 35, a j-th turn of the second wire 60 has the first crossing point CR1 where the j-th turn of the second wire 60 on the outside of an i-th turn of the first wire 50 crosses the i-th turn of the first wire 50. In addition, the j-th turn of the second wire 60 has the second crossing point CR2 where the j-th turn of the second wire 60 on the outside of a (j−1)-th turn of the second wire 60 crosses the (j−1)-th turn of the second wire 60. In addition, the (j+1)-th turn of the second wire 60 includes the specific part SP. Then, the specific part SP is directly wound around the winding core portion 11 and is located between the i-th turn of the first wire 50 and the j-th turn of the second wire 60 in the direction along the central axis C of the winding core portion 11.

### Effects of Embodiment

The above embodiment achieves the following effects.

(1) In the above embodiment, the 35th turn of the second wire 60 has the first crossing point CR1. Thus, space is formed in the direction along the central axis C around the 35th turn of the second wire 60. On the other hand, the 36th turn of the second wire 60 includes the specific part SP. Then, the specific part SP is directly wound around the winding core portion 11 and is located between the 35th turn of the first wire 50 and the 35th turn of the second wire 60 in the direction along the central axis C of the winding core portion 11. That is, a space on the positive direction X1 side of the 35th turn of the second wire 60 is used as a space for winding the 36th turn. This winding structure contributes to high-density winding of the second wire 60.

The part of the 36th turn of the second wire 60 closer to the second wire end 62 than the specific part SP has the third crossing point CR3 where the 36th turn of the second wire 60 on the outside of the 35th turn of the second wire 60 crosses the 35th turn of the second wire 60. In this manner, the second wire end 62 of the second wire 60 can be connected to the fourth outer electrode 44 by crossing the second wire 60 again. Then, at the third crossing point CR3, the second wire 60 is apart from the first wire 50 in the upward direction Y1. Thus, the dimension of the winding core portion 11 in the direction along the central axis C does not necessarily have to include a dimension for disposing the third crossing point CR3 of the second wire 60.

(2) In the above embodiment, the specific part SP of the second wire 60 includes the part located on the first edge line R1 of the winding core portion 11. The second wire 60 is pressed against the winding core portion 11 on the first edge line R1 by comparatively great force. Thus, with the above configuration, it is possible to inhibit winding deviation from occurring around the specific part SP.

(3) In the above embodiment, the last turn of the second wire 60 is the 36th turn. In other words, the first crossing point CR1, the second crossing point CR2, and the third crossing point CR3 concentrate in the last turn and the turn immediately before the last turn of the second wire 60. Thus, for example, by optical observation of the boundary portion between the winding core portion 11 and the second flange portion 31, it is possible to identify which direction the specific side surface 11A of the winding core portion 11 faces, that is, the orientation of the coil component 10.

(4) In the above embodiment, the first turn and the part closer to the first wire end 61 than the first turn of the second wire 60 do not include a part crossing the first wire 50 on the specific side surface 11A. On the other hand, as described above, the second wire 60 has the plurality of crossing points at the boundary portion between the winding core portion 11 and the second flange portion 31. Thus, by optical observation of each wire on the specific side surface 11A of the winding core portion 11, it is possible to identify the orientation of the coil component 10.

(5) In the above embodiment, the part of the 35th turn of the second wire 60 closer to the second wire end 62 than the first crossing point CR1 is wound around the outside between two adjacent turns. Specifically, this part is wound around the outside between the 34th turn of the first wire 50 and the 34th turn of the second wire 60. Thus, part of the force pressing the second wire 60 toward the central axis C side is dispersedly applied to the 34th turn of the first wire 50 and the 34th turn of the second wire 60. As a result, for example, it is possible to inhibit the first crossing point CR1 of the second wire 60 from being pressed against the first wire 50 by excessively great force.

(6) The part of the 35th turn of the second wire 60 closer to the second wire end 62 than the first crossing point CR1 is wound around the outside between identical turns of the first wire 50 and the second wire 60. Thus, the first wire 50 and the second wire 60 do not have to have a complex winding structure.

(7) In the above embodiment, the 35th turn of the second wire 60 has the second crossing point CR2 in addition to the first crossing point CR1. Thus, the force pressing the 35th turn of the second wire 60 toward the central axis C is dispersed not only to the first crossing point CR1 but also to the second crossing point CR2. Accordingly, it is possible to inhibit one of the crossing points from being pressed by excessively great force.

(8) In the above embodiment, all the first crossing point CR1, the second crossing point CR2, and the third crossing point CR3 of the second wire 60 are located on the specific side surface 11A. Thus, it is possible to observe the first crossing point CR1, the second crossing point CR2, and the third crossing point CR3 of the second wire 60 by only optically observing the specific side surface 11A of the winding core portion 11. That is, it is possible to identify whether each wire is wound as intended by design without observing the coil component 10 from different angles.

(9) In the above embodiment, when the second wire 60 is traced from the first crossing point CR1 to the second crossing point CR2 in the direction from the first wire end 61 side toward the second wire end 62 side, the second wire 60 extends from the second flange portion 31 side toward the first flange portion 21 side. In other words, the part of the second wire 60 from the first crossing point CR1 to the second crossing point CR2 is wound in the direction opposite to the direction in which the other part is wound. The winding density of the second wire 60 can be increased by winding the part in the vicinity of the crossing points of the second wire 60 in the opposite direction in this manner.

### Modification Examples

Modifications of the above embodiment can be implemented as described below. Combinations of the above embodiment and the following modification examples can be implemented without technical contradiction.

In the above embodiment, the configuration of the coil component 10 can be changed as appropriate. For example, the coil component 10 does not have to include the plate core 10F. In addition, the shape of the plate core 10F is not limited to the rectangular plate-like shape. For example, the plate core 10F may have an elliptical plate-like shape. In addition, a resin coating material that covers the lower surface of the first flange portion 21, the lower surface of the second flange portion 31, and the opposite surface 11B of the winding core portion 11 may be used instead of the plate core 10F.

In the above embodiment, the shape of the winding core portion 11 is not limited to the example of the above embodiment. That is, the shape of the winding core portion 11 is not limited to the quadrangular prism shape whose section has the rectangular shape. For example, the shape of the winding core portion 11 may be a quadrangular prism shape whose section has a square shape, a quadrangular prism shape whose section has a quadrilateral shape of other than a rectangular shape and a square shape, or a polygonal prism shape other than a quadrangular prism shape. In addition, the shape of the winding core portion 11 may be a circular cylinder shape or an elliptical cylinder shape.

In the above embodiment, the side surface having a larger area of the side surfaces of the winding core portion 11 is the specific side surface 11A. However, a surface having a smaller area thereof may be the specific side surface 11A. Even when the winding core portion 11 has a polygonal shape other than a quadrangular prism shape as in the above modification example, one of the side surfaces can be freely selected as the specific side surface 11A. When the winding core portion 11 has a polygonal shape other than a quadrangular prism shape, there may be no opposite surface 11B.

In the above embodiment, the material for the drum core 10C and the plate core 10F is not limited to the example of the above embodiment. For example, the material for the drum core 10C and the plate core 10F is not limited to Ni—Zn-based ferrite and may be Mn—Zn-based ferrite or other materials. In addition, the material for the drum core 10C and the plate core 10F may be, for example, ferrite, alumina, a synthetic resin, or a mixture of these materials.

In the above embodiment, the configuration of the drum core 10C is not limited to the example of the above embodiment. For example, the first flange portion 21 does not have to include the recessed portion 23. In this case, for example, it is sufficient that the first outer electrode 41 and the second outer electrode 42 be apart from each other. The same applies to the second flange portion 31.

In the above embodiment, the material and the shape of the first outer electrode 41 to the fourth outer electrode 44 are not limited to the examples of the embodiment. For example, the plating layer of each of the first outer electrode 41 to the fourth outer electrode 44 may be formed by a single conductive layer. In addition, each of the first outer electrode 41 to the fourth outer electrode 44 may include an exposed conductive metal layer without a plating layer. In addition, for example, each of the first outer electrode 41 to the fourth outer electrode 44 may be made of a plate-like metal material.

In the above embodiment, the sectional shape of the first wire 50 and the second wire 60 is not limited to the example of the above embodiment. For example, the sectional shape of the first wire 50 and the second wire 60 may be an elliptical shape or a rectangular shape.

In the above embodiment, the last turn number of the first wire 50 and the second wire 60 is not limited to the example of the above embodiment. In addition, the last turn number of the first wire 50 and the last turn number of the second wire 60 do not necessarily have to be equal to each other.

The specific part SP of the second wire 60 does not have to include the part located on the first edge line R1. For example, the specific part SP may exist only at the center of the specific side surface 11A of the winding core portion 11.

The first turn of the second wire 60 and the part closer to the first wire end 61 than the first turn of the second wire 60 may include a part crossing the first wire 50 on the specific side surface 11A. In the above embodiment, the second wire 60 has the plurality of crossing points at the boundary portion between the winding core portion 11 and the second flange portion 31. Thus, also when the second wire 60 has crossing points at the boundary portion between the winding core portion 11 and the first flange portion 21, it is possible to identify the orientation of the coil component 10 by optical observation.

The second crossing point CR2 of the second wire 60 is not indispensable. In some cases, the second crossing point CR2 can be omitted depending on the vicinity of the 35th turn of the second wire 60, the vicinity of the 35th turn of the first wire 50, and the position of each outer electrode, for example.

The part of the 35th turn of the second wire 60 closer to the second wire end 62 than the first crossing point CR1 does not have to be wound around the outside between the 34th turn of the first wire 50 and the 34th turn of the second wire 60 on the specific side surface 11A. For example, the above part may be directly wound around the winding core portion 11 between the 34th turn of the first wire 50 and the 34th turn of the second wire 60. In addition, the above part may be wound around the outside between adjacent turns different from the 34th turn of the first wire 50 and the 34th turn of the second wire 60.

A turn of the second wire 60 other than the 35th turn may include the first crossing point CR1. In other words, the j-th turn of the second wire 60 does not have to be the turn immediately before the last turn.

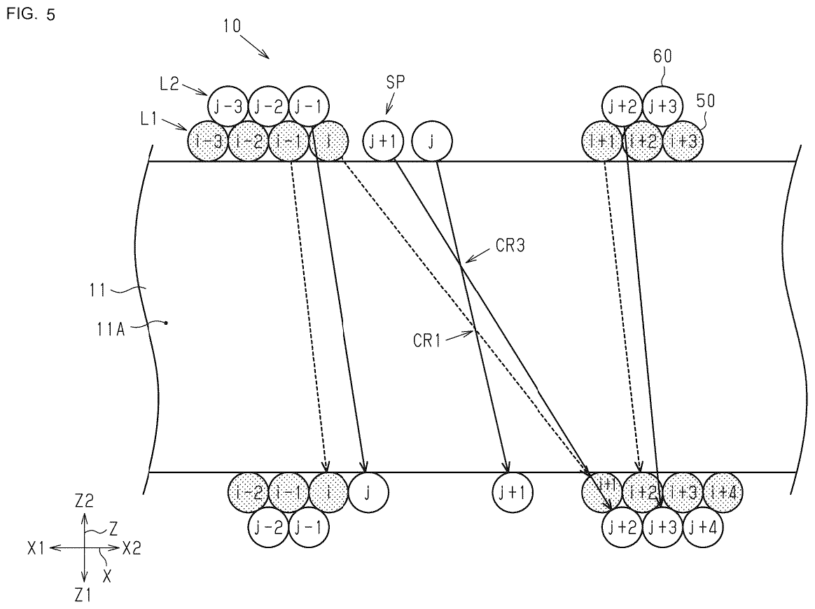

Specifically, in the example illustrated in FIG. 5, an (i−3)-th turn to an (i+4)-th turn of the first wire 50 are wound in the order so as to be located closer to the second flange portion 31 in the direction along the central axis C the higher the turn number. Although not illustrated, similarly, the first turn to an (i−4)-th turn of the first wire 50 are wound in the order so as to be located closer to the second flange portion 31 in the direction along the central axis C the higher the turn number. In addition, the (i−3)-th turn to a part of the i-th turn of the first wire 50 are wound adjacent to each other in the direction along the central axis C. An (i+1)-th turn to the (i+4)-th turn of the first wire 50 are wound adjacent to each other in the direction along the central axis C. Then, the other part of the i-th turn to the (i+1)-th turn of the first wire 50 are disposed so as to be spaced from a different turn of the first wire 50 adjacent in the positive direction X1. Thus, the (i−3)-th turn to the (i+4)-th turn of the first wire 50 belong to the first layer L1. FIG. 5 illustrates an exaggerated space between adjacent turns of the first wire 50. Although not illustrated, an (i+5)-th turn to the last turn of the first wire 50 are wound in the order so as to be located closer to the second flange portion 31 in the direction along the central axis C the higher the turn number.

Although not illustrated, the first turn to a (j−4)-th turn of the second wire 60 are wound around the outsides between adjacent turns of the first wire 50. As illustrated in FIG. 5, a (j−3)-th turn of the second wire 60 is located on the outside between the (i−3)-th turn and an (i−2)-th turn of the first wire 50. A (j−2)-th turn of the second wire 60 is located on the outside between the (i−2)-th turn and the (i−1)-th turn of the first wire 50. A part of the (j−1)-th turn of the second wire 60 is located on the outside between the (i−1)-th turn and the i-th turn of the first wire 50. Thus, the (j−3)-th turn to the part of the (j−1)-th turn of the second wire 60 belong to the second layer L2.

A part of the j-th turn of the second wire 60 is directly wound around the winding core portion 11 on the negative direction X2 side of the i-th turn of the first wire 50. Then, a part of the (j+1)-th turn of the second wire 60 is directly wound around the winding core portion 11 between the j-th turn of the second wire 60 and the (i+1)-th turn of the first wire 50. Thus, the j-th turn of the second wire 60 has the first crossing point CR1 where the j-th turn of the second wire 60 on the outside of the i-th turn of the first wire 50 crosses the i-th turn of the first wire 50. The other part of the (j+1)-th turn of the second wire 60 is directly wound around the winding core portion 11 between the i-th turn of the first wire and the j-th turn of the second wire. Thus, this part of the (j+1)-th turn of the second wire 60 is the specific part SP. Then, the (j+1)-th turn of the second wire 60 crosses the j-th turn of the second wire 60. That is, the (j+1)-th turn of the second wire 60 has the third crossing point CR3.

A (j+2)-th turn of the second wire 60 is located on the outside between the (i+1)-th turn and an (i+2)-th turn of the first wire 50. A (j+3)-th turn of the second wire 60 is located on the outside between the (i+2)-th turn and an (i+3)-th turn of the first wire 50. A (j+4)-th turn of the second wire 60 is located on the outside between the (i+3)-th turn and the (i+4)-th turn of the first wire 50. Then, although not illustrated, a (j+5)-th turn to the last turn of the second wire 60 are wound around the outsides between adjacent turns of the first wire 50.

In the modification example illustrated in FIG. 5, the part of the (j+1)-th turn of the second wire 60 may be wound around the outside between the j-th turn of the second wire 60 and the (i+1)-th turn of the first wire 50.

What is claimed is:

1. A coil component comprising:
a winding core portion having a columnar shape;
a first flange portion at a first end of the winding core portion in a direction along a central axis of the winding core portion;
a second flange portion at a second end of the winding core portion opposite to the first end;
a first outer electrode and a second outer electrode that are on the first flange portion;
a third outer electrode and a fourth outer electrode that are on the second flange portion;
a first wire wound around the winding core portion, the first wire having a first wire end and a second wire end, the first wire end of the first wire being connected to the first outer electrode, the second wire end of the first wire being connected to the third outer electrode; and
a second wire wound around the winding core portion in the same direction as the first wire, the second wire having a first wire end and a second wire end, the first wire end of the second wire being connected to the second outer electrode, the second wire end of the second wire being connected to the fourth outer electrode, wherein
each time the first wire is wound around the central axis in a direction from the first wire end toward the second wire end and forms one turn, a number of turns of the first wire increases by one, and
each time the second wire is wound around the central axis in a direction from the first wire end toward the second wire end and forms one turn, a number of turns of the second wire increases by one,
a j-th turn (j is an integer of 2 or more) of the second wire has a first crossing point where the j-th turn of the second wire on an outside of an i-th turn (i is an integer of 2 or more) of the first wire crosses the i-th turn of the first wire,
a (j+1)-th turn of the second wire includes a specific part between the i-th turn of the first wire and the j-th turn of the second wire in the direction along the central axis of the winding core portion, and
a part of the (j+1)-th turn of the second wire closer to the second wire end than the specific part on an outside of the j-th turn of the second wire crosses the j-th turn of the second wire.

2. The coil component according to claim 1, wherein
the winding core portion has a polygonal prism shape, and
when one of side surfaces of the winding core portion is a specific side surface, one of two edge lines between the specific side surface and other ones of the side surfaces adjacent to the specific side surface is a first edge line, and another of the two edge lines is a second edge line,
the second wire passes the first edge line and the second edge line in this order on the specific side surface when the second wire is traced from the first wire end to the second wire end, and
the specific part of the second wire includes a part on the first edge line.

3. The coil component according to claim 1, wherein
the (j+1)-th turn of the second wire is a last turn of the second wire.

4. The coil component according to claim 1, wherein
the winding core portion has a polygonal prism shape, and
when one of side surfaces of the winding core portion is a specific side surface,
a first turn and a part closer to the first wire end than the first turn of the second wire do not include a part crossing the first wire on the specific side surface.

5. The coil component according to claim 1, wherein
a (j−1)-th turn of the second wire includes a part wound around an outside between adjacent turns of the first wire, and
a (j+2)-th turn of the second wire includes a part wound around an outside between adjacent turns of the first wire.

6. The coil component according to claim 5, wherein
a first turn to the (j−1)-th turn of the second wire are wound around outsides between adjacent turns of the first wire, and
the (j+2)-th turn to a last turn of the second wire are wound around outsides between adjacent turns of the first wire.

7. The coil component according to claim 2, wherein
the (j+1)-th turn of the second wire is a last turn of the second wire.

8. The coil component according to claim 2, wherein
the winding core portion has a polygonal prism shape, and
when one of side surfaces of the winding core portion is a specific side surface,
a first turn and a part closer to the first wire end than the first turn of the second wire do not include a part crossing the first wire on the specific side surface.

9. The coil component according to claim 3, wherein
the winding core portion has a polygonal prism shape, and
when one of side surfaces of the winding core portion is a specific side surface,
a first turn and a part closer to the first wire end than the first turn of the second wire do not include a part crossing the first wire on the specific side surface.

10. The coil component according to claim 7, wherein
the winding core portion has a polygonal prism shape, and
when one of side surfaces of the winding core portion is a specific side surface,
a first turn and a part closer to the first wire end than the first turn of the second wire do not include a part crossing the first wire on the specific side surface.
